(19) United States
(12) Patent Application Publication
(10) Pub. No.: US 2016/0267068 A1
(43) Pub. Date: Sep. 15, 2016

(54) SYSTEM, METHOD AND PROCESS FOR MULTI-MODAL ANNOTATION AND DISTRIBUTION OF DIGITAL OBJECT

(71) Applicant: RAJA NAGARAJAN, SAN RAMON, CA (US)

(72) Inventor: RAJA NAGARAJAN, SAN RAMON, CA (US)

(21) Appl. No.: 14/645,363

(22) Filed: Mar. 11, 2015

(51) Int. Cl. G06F 17/24; G06F 17/30

(52) U.S. Cl. CPC G06F 17/241; G06F 17/3089

(57) ABSTRACT

Instant process, collectively through publisher, consumer and the backend server intelligence provides an intelligent multi-modal annotation and distribution of digital object. The methodology seamlessly creates and disseminates digital object and hotspots (a selected portion of the picture) to a group that can collectively view, manage, comment and enhance it. The process allows hotspots to define vendor information where orders can be placed to procure a selected entity notified in a hotspot. More particularly, it relates to an intelligent dissemination of digital information by a publisher to a group of consumers seamlessly over network. This disclosure also relates to a comprehensive methodology of annotating in multimode digital object by creating hotspots and identifying vendor, personal, geographical and other information for a group to comment, acquire vendor information, order from vendor through the process, rate, trend, enhance and debate the entity in the digital object.

### FIELD OF TECHNOLOGY

This disclosure relates generally to a method, process and system for multi-modal annotation and distribution of digital object. More particularly, it relates to an intelligent dissemination of information by a publisher and user using their social connectivity with applicability both in the Enterprise and Consumer space.

### BACKGROUND

The existing technology allows users to annotate their pictures and albums as a title. One may make a text box on the pictures in jpeg or pdf format to point to a particular place of interest in the picture. However, sharing is predominantly done using email and social media pages.

InfoTrends' 2014 Worldwide Image Capture Forecast estimates consumers have taken 810 billion photos worldwide in 2014. This number is expected to grow to 1 trillion photos in 2015 and 1.3 trillion photos by 2017. The compound annual growth rate (CAGR) from 2014 to 2017 will be 16.2%. This growth will be driven by the increased ownership and use of mobile phones. In 2014, the number of photos captured by mobile phones was estimated to be 560 billion; and in 2015 it is expected that 748 billion photos will be taken using our phones.

The social networking images footprint is estimated to be around 550B photos shared a year and growing fast, expecting to touch over 1 trillion soon. One of the basic approaches adopted by the current sharing of digital photo is where the image is viewed as whole object and commentary about the same is listed as an independent thread. The focus of the photo sharing has been more around the effects that can be generated on the photo. With the improvement in the resolution and the zoom capabilities of an image, we believe that there will be an increasing need to see and understand the intricacies of the photograph; define and interact on specific points in them. There is a need for a seamless annotation process with more details for people to remember later or share meaningfully.

### SUMMARY

Several embodiments for a system, method and process for a multi-modal annotation and distribution of digital object are disclosed. The proposed system, process and method enables creation of multi-modal annotation digitally for a given digital object, allows edits, distribution, archival, deletion by an individual, group and/or to a community. In one embodiment, the system, process and method reinvigorates static digital content by providing mechanisms via annotation and interaction with other producers/users.

In one embodiment, the system comprises of multi-modal annotation tool which can be used as an application, in an embedded system and/or an enterprise system level. The system uses a processor of a mobile device, internet, databases, computers, tablets etc., for multi-modal annotation of digital object for distribution and dissemination.

In one embodiment, at an enterprise level, multi-modal annotation tool will provide a platform for the enterprise to be used for multiple applications; example of a few being digital catalog interactions with its subscribers and service delivery management (where support is enabled of a product by posting picture of the product with the specific problem called out as a hotspot).

In another embodiment, publishers can publish a photo with hotspots and make available in the network for viewing and allowing discussion around the digital object allowing partial ownership and publishing rights.

In another embodiment, a publisher can create a group to administer a discussion based on the digital object published. Being an administrator provides the publisher the privilege to monitor the publication, deleting the comments of individual or group timelines. Publisher can also delete or modify their multi-modal annotations/hotspots. This system, process and method enable's enterprise centric focus groups to discuss products and engage with new users.

In one embodiment, a system has multiple modules to support the system, method and process of multi-modal annotation tool to work efficiently. A publisher intelligence module, in one embodiment, communicates with a consumer intelligence module via LAN/WAN, wireless, 2G, 3G, LTE and internet. In another embodiment backend intelligence stores data from the publisher intelligence module and consumer intelligence module into redundant information database and redundant user knowledgebase for saving, retrieval and archival purposes in real time.

In one embodiment, a hotspot module is used to annotate a hotspot attribute on a digital object using a multi-modal annotation tool by a publisher of the digital object. In another embodiment, a content module is used by the publisher to manage access, select a part of the digital object, update, delete and send functions of the digital object to a user. In another embodiment, an operations module is used to create a single file with the hotspot attribute on the digital object. Finally, a network module is used to communicate between the publisher and the user/consumer.

In another embodiment, a backend intelligence module is used to store an annotated hotspot using a vault management for the publisher's content. In one embodiment, the hotspot attribute is at least one of a text, audio, video, photo, web address and geological location. The publisher intelligence module is used for categorizing the annotated hotspot for a given collection in a vault of the publisher. The digital object is at least one of a photo, video, document and scanned images, but not limited to these examples.

In one embodiment, as a method, a specific point of interest in a digital object may be pinpointed and selected for creating an hotspot attribute and be defined by multi-modal annotation tool. In another embodiment, the multi-modally annotation tool created hotspot attributes are bound to the image seamlessly. In another embodiment, these hotspot attributes have the capacity to be seen over a digital image; may be seen in a zoomed view and landscape/portrait orientation. The hotspot attributes move according to the orientation of the digital object and automatically and seamlessly adjust.

In one embodiment, a digital object may be picture, photograph, audio file, video file, a document, a screen shot or an image. Using this system, in one embodiment, a producer of the hot spotted digital object may choose to share this file with the contacts in their phone, web based social media or on an enterprise level. In the instant system, in one embodiment, a container (metadata along with the digital object) is stored in the server, the sharing is performed using only one file and the every recipient user only gets a view of the same file, thus allowing consistency of file and avoid issues around redundancy. The hotspot attributes may be shown as a position on the photograph, file, and image using multi-modal annotation are, but not limited to, text, audio, web link and video. Architecturally, these hotspot attributes are managed as leaves on a node allowing definition and addition of new hotspot attributes.

In one embodiment, the hotspot management (definition and attaching of multi-modal annotation) are portable and can be extended to any digital object including documents and videos.

One of the other commonly faced challenges is to manage ownership, the extent of sharing and managing information in the network. With the instant system, method or process called multi-modal annotation tool, there is only one owner of the digital object such a photo (the others can only get a view of the same and will not be able to download or save the same on their device), and the publisher (photo owner) can choose specific hotspots she/he wants to share with specific users. Also, a publisher can choose to delete specific users from the photo share. The recipient of the hotspots enabled images can engage with publisher by asking questions on the photograph.

In one embodiment, the method allows to choose a picture from the gallery or take a digital object through a device such as camera within said process environment for creation of hotspots. In one embodiment, the selected digital object can be edited to add/modify hotspots and to define an element of the picture. In one embodiment, colors can be chosen to define the hotspot highlighting any section of the picture by zooming in/out of the picture. Attributes of the hotspot can be added through multi-modal annotation, such as text, URL, audio, photo, video, document and Geo-location (Geoloc) information In one embodiment, the hotspots can be categorized based on the object, vendor, item, travel tip, shopping information and personal data. In one embodiment, the process allows “snip” a portion of a picture and save it as another picture. In another embodiment, these saved snips can be enhanced in the form of a collage and shared. In another embodiment, the shared picture can be done within the group, or entire community.

In one embodiment, instant method allows to start a conversation around a digital object posted within the group network or community broadcast within instant network. In another embodiment, the methodology allows communicating on the publisher's hotspots and posts multi-modal annotation using text, audio, video and URL comments, including questions and answers. In another embodiment, the methodology allows the analytics to provide trending information on the posts. The methodology allows the definition of private and public elements/hotspots of a picture. It also allows sharing different elements with different network members and sharing the hotspots selectively with different members/users/consumers.

In one embodiment, instant process allows to choose areas of interest and follow community of publishers, retailers and celebrities that are identified as part of hotspots. In one embodiment, the process allows engaging, interacting with community to get answers, research, shop and review the products shown as part of digital object. In another embodiment, the process allows through alerting mechanism for new products, news items, catalogs, promotions, trending items within the subset of community of interest.

In one embodiment, instant intelligence engines (publisher, consumer and backend) provide enrichment of information around the hotspots created by publisher, received by consumer and evaluated by the group in general. The intelligence engines cover the areas of interest using multiple sources of information such as web, community of publishers, retailers, and instant network of members. In one embodiment, the response combines elements of semantics, metadata parsing and real-time information. In another embodiment, the engine provides information specific to a publisher/consumer interest, using Pull rather than Push mechanism. The eventual goal of this is for the ability to provide a mechanism to facilitate commerce around the annotated digital object.

In one embodiment, the users can register areas of interest on instant process and get access to picture stream of that area with hotspots published to them. In this embodiment, when a Publisher annotates a picture with hotspots and chooses entire instant network as the option to publish, the picture with that hotspot(s) becomes available to entire network. The post will appear on the consumer's community timeline based on the interest area chosen. The interaction model in this case is between publisher and multiple consumers with the comments/questions being available for viewing to the entire network.

In another embodiment, Retailers/Manufacturers can interact with instant process and users through catalog by publishing catalog with hotspots and attracting subscription. Access to user generated pictures of a retailer's products is used for product offerings. Manufacturers can use instant process as a support channel. The catalog and interaction through hotspot can capture the user journey from viewing to checkout.

The system, method and process disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates the publisher and consumer access architecture.

FIG. 2 illustrates the end to end architecture of the instant methodology.

FIG. 3 illustrates the publisher and consumer LAN architecture.

FIG. 4 illustrates an embodiment of publisher architecture.

FIG. 5 depicts the publisher intelligence functions and their module dependencies on other functionalities within the publisher architecture.

FIG. 6 depicts the consumer architecture where it interfaces to the access devices such as laptop, smart phones, desktops and tablets through LAN and Wireless LAN.

FIG. 7 shows the consumer intelligence functions and their module dependencies on other functionalities within the consumer architecture.

FIG. 8 shows the back end intelligence interfacing both Publisher and Consumer.

FIG. 9 illustrates the producer interactions to create account, hotspots and posting messages to consumers.

FIG. 10A and 10B show the start screens of the application for multi-modal annotation.

FIG. 11A, 11B and 11C show the hotspot selection module as a method.

FIG. 12A and 12B show that once the hotspot is created it may either be posted or deleted.

FIG. 13A and 13B show the process of posting and the success of posting being acknowledged.

FIG. 14A and 14B is an overall digital visual image view of the instant method.

FIG. 15A and 15B show another hotspot creation using details of the geographical location and date.

FIG. 16A and 16B show the interest of the user and based on that a selection to be made for multi-modal annotation.

FIG. 17A and 17B shows that a vault is being used for storing and adding new things into the software for multi-modal annotation.

FIG. 18A and 18B shows that a clipping of the bigger picture may done to be added in the vault with hotspot on it.

FIG. 19A, 19B and 19C shows a process of hotspot annotation using the system and method.

FIG. 20A, 20B and 20C show the user side when allocation that they can question the hotspot and participate.

Other features of the present embodiments will be apparent from the accompanying drawings and from the detailed description that follows.

### DETAILED DESCRIPTION

Several systems, methods and process for multi-modal annotation tool and distribution of digital object that has been annotated using the multi-modal annotation tool to a group over specific network are disclosed. Although the present embodiments have been described with reference to specific example embodiments, it will be evident that various modifications and changes may be made to these embodiments without departing from the broader spirit and scope of the various embodiments. This disclosure also relates to a comprehensive methodology of annotating in multi-mode digital object by creating hotspots and identifying vendor, personal, geographical and other information for a group to comment, acquire vendor information, order from vendor through the process, rate, trend, enhance and debate the entity in the digital object.

The terminology used for these embodiments include; “hotspots” to indicate annotations; “publisher” for the entity that owns the annotated digital object, “consumer” and/or “user” for the entity that receives the annotated digital object.

Publisher is the one who owns the image or digital object that is being published. In one embodiment, publisher creates deletes, edits digital object and creates, deletes hotspots. The publisher selectively and wholly shares hotspot attribute/s with members. The publisher, in one embodiment, can create groups and invite friends to be part of the group. Publisher can selectively and completely delete the post.

Consumer and/or user are one who receives the digital object in the form of a post from the publisher with the hotspot attributes assigned to her/him. Consumer can comment on the Post, comment on hotspot attributes, rate the hotspots and can ask a question on the image/digital object to the publisher. Consumer can hide a post and remove it from their timeline. Consumer cannot modify the hotspot attribute neither can she/he forward the same. Consumer can add/modify hotspot attribute on the shared post if the publisher grants rights to the same—but the owner of the image still remains the original publisher. Consumer can pick areas of interest and can subscribe to image stream from system and software that are tagged to the interest area. Consumer and/or user are used interchangeably used throughout this application.

A digital object such as a photograph may be used by the publisher to add hotspots. Image can be created either from the stored photo gallery or shot taken from the phone camera. Image can be viewed in both landscape and portrait mode. Image can be zoomed to the level supported by the phone. Image's ownership and responsibility are with the publisher and future sources include public sources/syndicated sites.

Hotspot attributes are objects used to define a particular point on the digital object or data. Hotspot attribute creation supports multi-colors to balance the contrast of the background color of the image. Hotspots are defined by hotspot attributes entered by the publisher. Attributes are multi-modal and the example, is not limited to, color, label, text, audio, URL, video, photo and document. Hotspots are relatively positioned on the image. Hotspots adjust according to the action—Landscape/Portrait View, Zoom/Pinched View. True Binding based on the resolution chosen by the publisher can be accomplished in hotspot. If the publisher enhances the image and adds a hotspot, it will appear back in the same view as it was saved.

A publisher can post an image to her/his friends with the hotspots. A time can be assigned for a post. On expiration of the time, the post will get deleted from all timelines that it was shared. Publisher can selectively share hotspots with different friends. That way, all friends will get the same image, but may have different hotspots shared with them. Publisher can Update a post (make changes to the existing post—for the same hotspot, change, color, add another attribute) and share it or the publisher can repost the image with new information and hotspots. Repost create a new image in the vault. Publisher can delete the post either from all the consumer timelines or from selected consumer's timeline (Poster's Remorse). When a Consumer views a Post, she/he can comment on the Post, rate the hotspot or ask a question to the publisher by placing a “?”, on the image. When the publisher gets the “?”, she/he can either respond to the question privately to the consumer or convert the “?” into a hotspot and post it again. Publisher can give permission to a consumer to temporarily Edit a Post or add/modify to a post.

A multi-modal annotation tool is a software tool that enables a producer to create hotspot with hotspot attribute to annotate a digital object and enables a consumer/user to query and see the hotspot that has been annotated as a hotspot attribute. A digital object is at least one of a file, word file, photo, video, web page, any electronic file or combination thereof.

The server intelligence over network provides a central location for all producers/users to see the posts that they have made or view the posts that have been shared with them. When a consumer comments on the hotspot, it is visible to all the consumers who have received the hotspot. Similarly, when a consumer comments on the post, the comment is available to all the consumers who have received the post.

Instant system, method and process, collectively through publisher, consumer and the backend intelligence modules residing on servers provide an intelligent way for multi-modal annotation and distribution of digital object. The methodology seamlessly creates and disseminates digital object, hotspots (a selected portion of the picture) and hotspot attributes to a group that can collectively view, manage, comment and enhance it. The process allows hotspots to define vendor information where orders can be placed to procure a selected entity notified in a hotspot. The process provides the complete mechanism for analytics and metrics to gather and analyze the usage and trending data.

Instant method and process comprises of many steps. The publisher publishes the digital object through multicast or broadcast to a group of friends. Consumer receives the published data being part of the group or community. Images are those that are captured directly from camera or saved previously in vault or clipboard. Hotspot is a selection of a subset of the digital object for further analysis, validation and multi-modal annotation. Vault is an internal space where prearranged digital object specific to publisher is available. Clipboard is an internal space where a selected subsection of a snipped picture is temporarily stored. Friends and contacts are a subgroup identified and verified to form a clique. Group is a collection of users. Server is a gateway that manages publisher and consumers and everything else as part of the process. Post is a function to send information over the network to the group.

A user can choose the areas of interests, namely travel, business, entertainment and personal, either at the time of signup or during a session. Once the selection is done, the user gets information of catalogs and user-groups. The user can switch ON/OFF the feeds.

In the proposed methodology, we show how such an intelligent system can be created where the multi-modal annotation and distribution of digital object and hotspots can be seamlessly shared between publisher and consumers and debated.

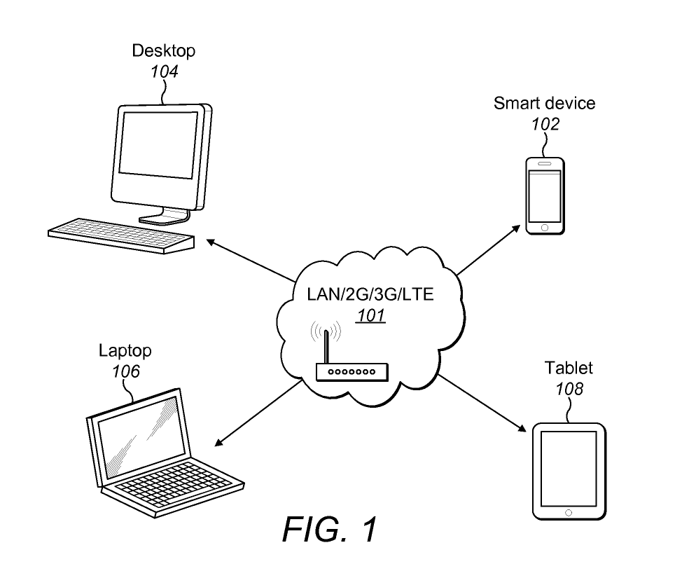

FIG. 1 illustrates a closer view of access architectures of the multi-modal annotation tool system, method and process. The publisher/user is connected to the internet directly via cellular network or via a Wireless LAN through a wireless router or a LAN 101. The devices through which the publisher creates and disseminates the digital object can be from a desktop 104, a smart device 102, a laptop 106 and a tablet 108.

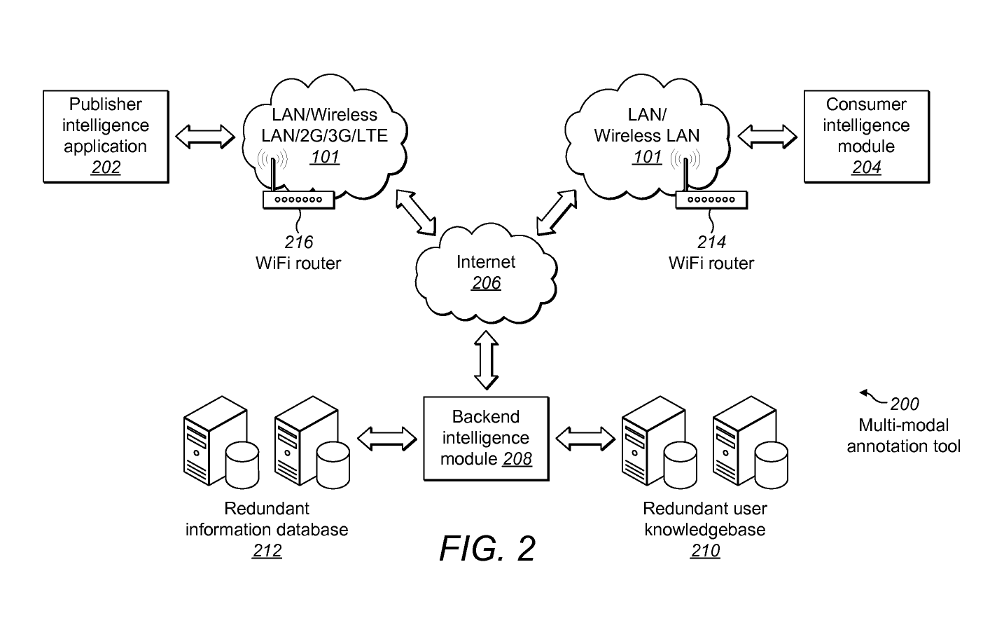

FIG. 2 illustrates the end to end architecture of the instant multi-modal annotation tool 200 for digital object, such as a visual image, annotation and distribution. In one embodiment, the architecture shows a publisher intelligence module 202 that creates the digital object to be distributed either through a multicast to a group or broadcast to general users. In one embodiment, the architecture shows a consumer intelligence module 204 which is either part of the group or a general user who is connected to the publisher. In one embodiment, the backend intelligence module 208 is shown to enable the functionality to communicate between a publisher intelligence module and several consumer intelligence modules. In one embodiment, the publisher intelligence module 202 is connected to the consumer intelligence module 204 through Internet 206 via a LAN or a Wireless LAN or a cellular network using 2G/3G/LTE 101 using WiFi routers 214 and 216. The backend intelligence module 208, as a server communicates between the two clients, namely publisher intelligence module and consumer intelligence module. The backend intelligence module 208 uses the redundant user knowledgebase 210 for authentication purposes. The redundancy provides the required fault tolerance. Similarly, the backend intelligence module 208 uses the redundant information database 212 for digital object purposes.

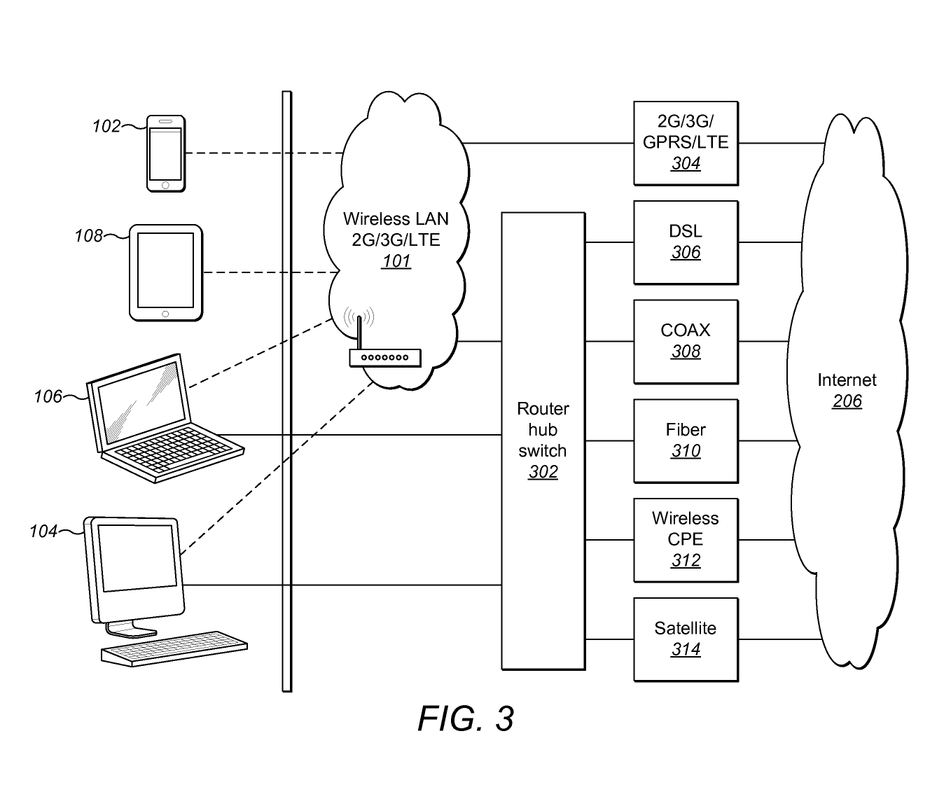

FIG. 3 illustrates access architecture for publisher and consumer via LAN and Wireless LAN or directly over a cellular network 101. The four categories of access equipment, namely smart phone 102, tablet 108, laptop 106 and desktop 104 are connected to the Wireless LAN equipment through a wireless router 302. If cellular network interface is available, the Internet connectivity from the smart device 102 could be direct to Internet 206. In some cases, the equipment have either wired or wireless interface, and can connect to the LAN directly through a router, hub or a switch 302 using a cable. In one embodiment, the publisher can use a desktop 104 to connect to Internet 206 through a wired router 302 using an Ethernet cable 304. The access connectivity to Internet could be through several mediums. In one embodiment, the multi-modal digital object can be sent through DSL 306. In another embodiment, the data can be sent through a COAX cable 308. In another embodiment, the data can be through a fiber 310. The Internet could be directly from a point-to-point or a point-to-multipoint wireless medium using Wireless CPE 312. Similarly, the Internet 206 can also be obtained through satellite medium 314.

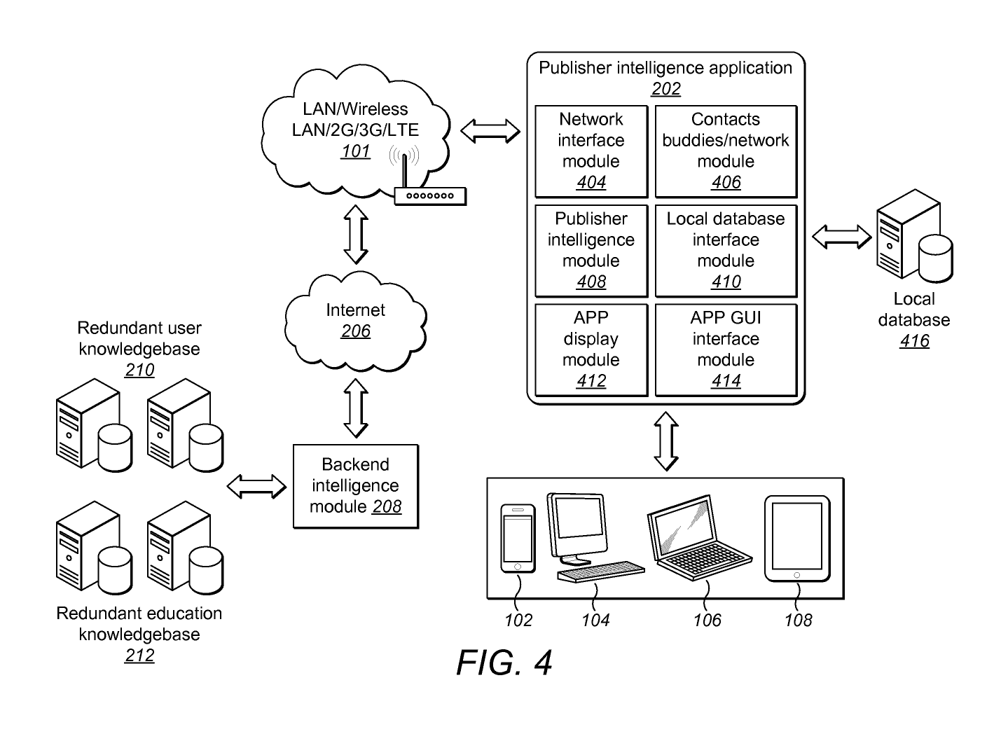

FIG. 4 illustrates the publisher architecture where it interfaces to the access devices such as laptop, smart phones, desktops and tablets through LAN and Wireless LAN. The publisher connects to Internet 206 through a LAN or a Wireless LAN 101 or a cellular 2G/3G/LTE interface. The publisher has six main functionalities. The Network Interface module 404 provides the device driver and connectivity to the network element. The contacts buddies/network module 406 functionally maintains all the local information about the group. The publisher intelligence module 408 is the brain process of the publisher functionality as a whole and handles the publisher interaction with consumers and the backend intelligence. The local database interface module 410 handles the communication with the local database 416 that has all the information stored in it. The App display module 412 contains the functionality of all the screen display in access devices. The App GUI interface module 414 provides the graphical interface to this application in all the publisher devices, namely smart phone 102, desktop 104, laptop 106 and tablets 108. The backend intelligence module 208 server is the process that manages the publisher and consumer interactions in addition to controlling the application status. The user information is stored in a fault tolerant redundant education knowledgebase 212 while the application information is stored in redundant user knowledgebase 210.

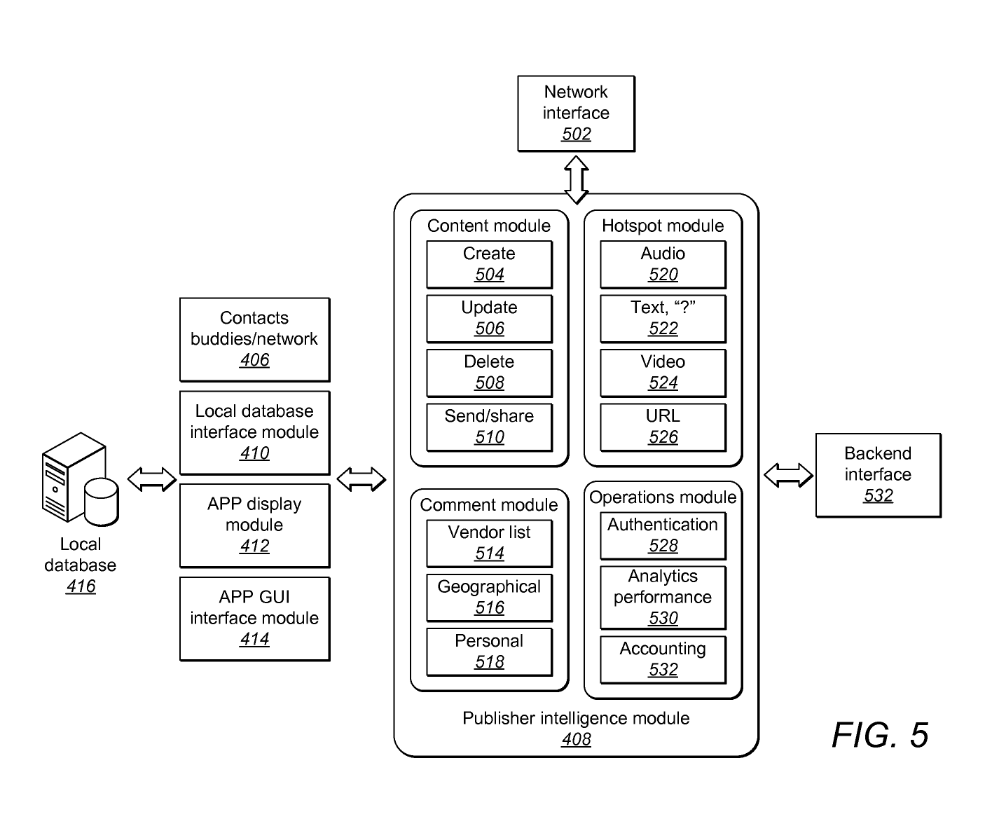

FIG. 5 illustrates the publisher intelligence module 408 dependencies. The publisher intelligence module 408 is the heart of the publisher application present in the devices that publisher uses. The publisher intelligence module 408 connects through the network interface module 502 to the Internet via LAN. The publisher intelligence module 408 also connects to the contacts, buddies and network modules 406 to access the group contact information, App display module 412 and App GUI interface module 414 to access the device display. It also uses the local database 416 interface to access the digital object from local database. The intelligence module uses the backend interface APIs 532 to communicate with the backend intelligence module 208. The local database 416 has the content for contacts buddies/network 534, connects using local database interface 536, application (APP) display 538 and application graphical user interface 540.

FIG. 5 provides the modules within publisher intelligence function 704. There are four different sub-functions modules namely Content, Comment, Hotspot and Operations. Content module provides the utility to create 504, update 506, delete 508 and send/share 510 an annotated digital object. The comment module provides the utility to manage vendor list 514, geographical data 516 and personal data 518. For example, in one embodiment a digital object could contain a hotspot that describes a car, which is from a vendor list 514. In another embodiment, a digital object could contain a hotspot content that describes location of Eiffel tower, which is geographical information 516. In another embodiment, a digital object could contain a hotspot content that describes a family photo with personal information 518. The hotspot module provides the multi-modal utilities to comment through audio 520, text details 522 or questions 522, video 524 and URL 526. The operations module provides utilities to authenticate 528 a connection and session. The operations also have analytics and performance 530 showing information such as time, bandwidth, number of connections, likes, ratings, trending items and other interests. The operation also provides accounting utility 532 to track finance data.

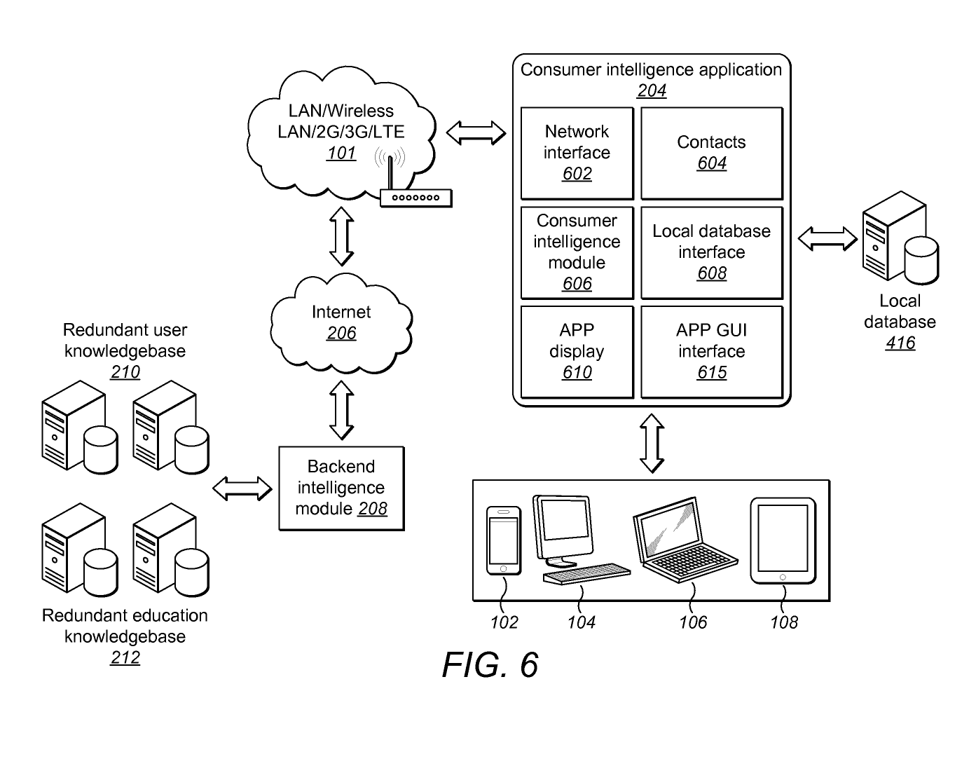

FIG. 6 shows the consumer intelligence module 204 comprises of six main modules, namely network interface 602, consumer intelligence 606, app display 610, contacts 604, local database interface 608 and app GUI interface 615. The consumer connects to the Internet 206 through the network interface and LAN/Wireless LAN or cellular interface module 101. The contacts 604 contain the group information and the publisher contacts. The consumer intelligence 606 is the heart of the consumer application that interfaces with its management server entity, the backend intelligence 208. The App display 610 provides the device display management facility. Consumer intelligence 606 accesses the local database 416 through local database interface 608 to obtain multi-modal annotation tool enabled annotated digital object. Consumer intelligence 606 uses App GUI interface 615 to provide graphical user interface to the consumer access devices, namely smart phone 102, desktop 104, laptops 106 and tablet 108. These devices are limited to only these examples but may also comprise of wearables, etc.

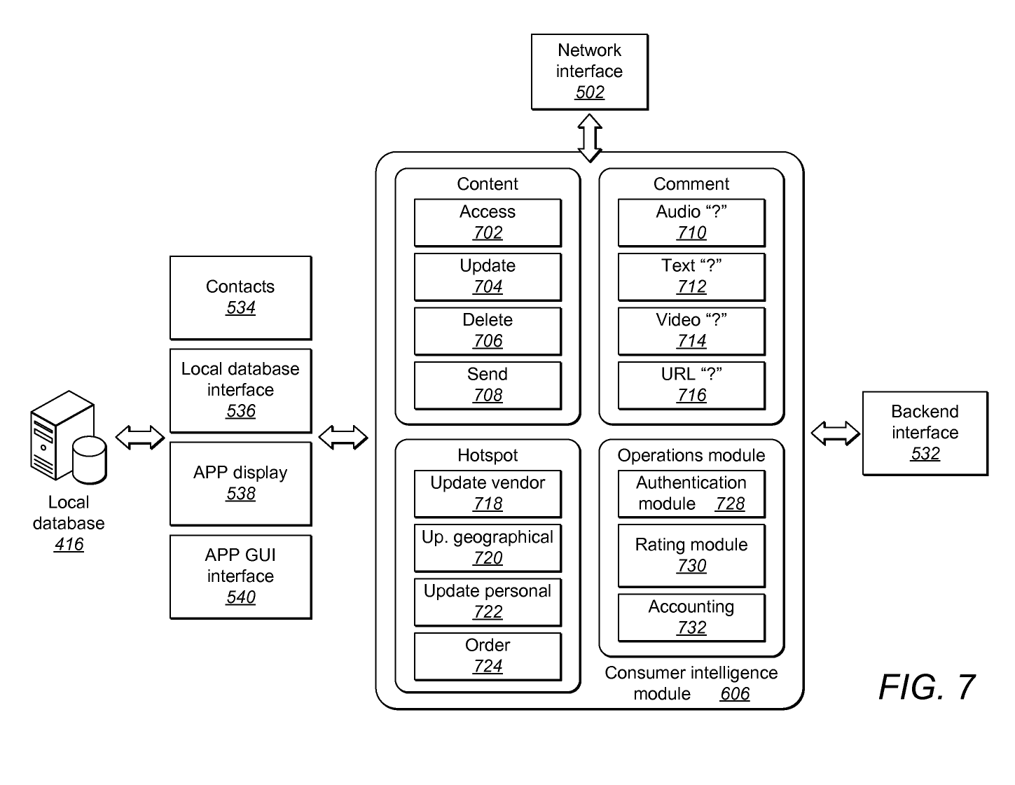

FIG. 7 illustrates the modules within consumer intelligence module 606. There are four different sub-functions namely Content, Comment, Hotspot and Operations. Content sub-function provides the utility to access 702, update 704, delete 706 and send 708 a multi-modal annotation tool enabled annotated digital object. The hotspot sub-function provides the utility to update vendor 718 that has already been recorded as part of publisher's hotspot. Similarly the geographical data can be updated 720, personal data can be modified 722 if permission has been granted by the publisher to modify. The consumer also has the method to order 724 from the vendor the product highlighted by the hotspot. For example, in one embodiment a digital object could contain a hotspot that describes a car, which is from a vendor list and the consumer can update it. In another embodiment, a digital object could contain a hotspot that describes location of Eiffel tower, which is geographical information 720 and the consumer can update it if given permission. In another embodiment, a digital object could contain a hotspot that describes a family photo with personal information 722 which the consumer can enhance it. The comment sub-function provides the multi-modal utilities to comment through audio 710, text details 712, video 714 and URL 716. The operations sub-function provides utilities to authenticate 728 a connection and session. The operations also have rating module 730 analytics and performance showing information such as time, bandwidth, and number of connections, vendor statistics, likes and other interests. The operation also provides accounting utility 732 to track finance data. The backend interface 532 allows the consumer to contact backend intelligence to manage the application.

FIGS. 6 and 7 together illustrate the consumer architecture and consumer intelligence module. The publisher and consumer communication is handled mostly by their respective intelligence module in conjunction with the backend intelligence. The multi-modal annotation and distribution of the digital object is handled by the publisher intelligence.

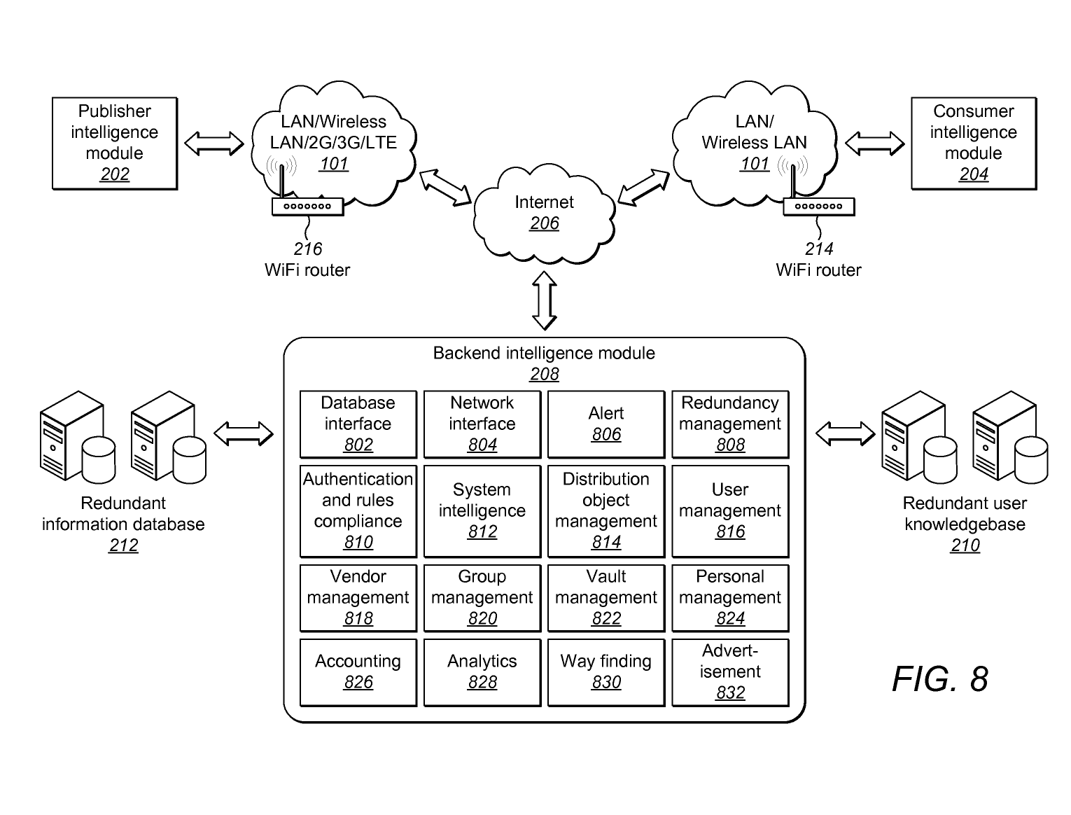

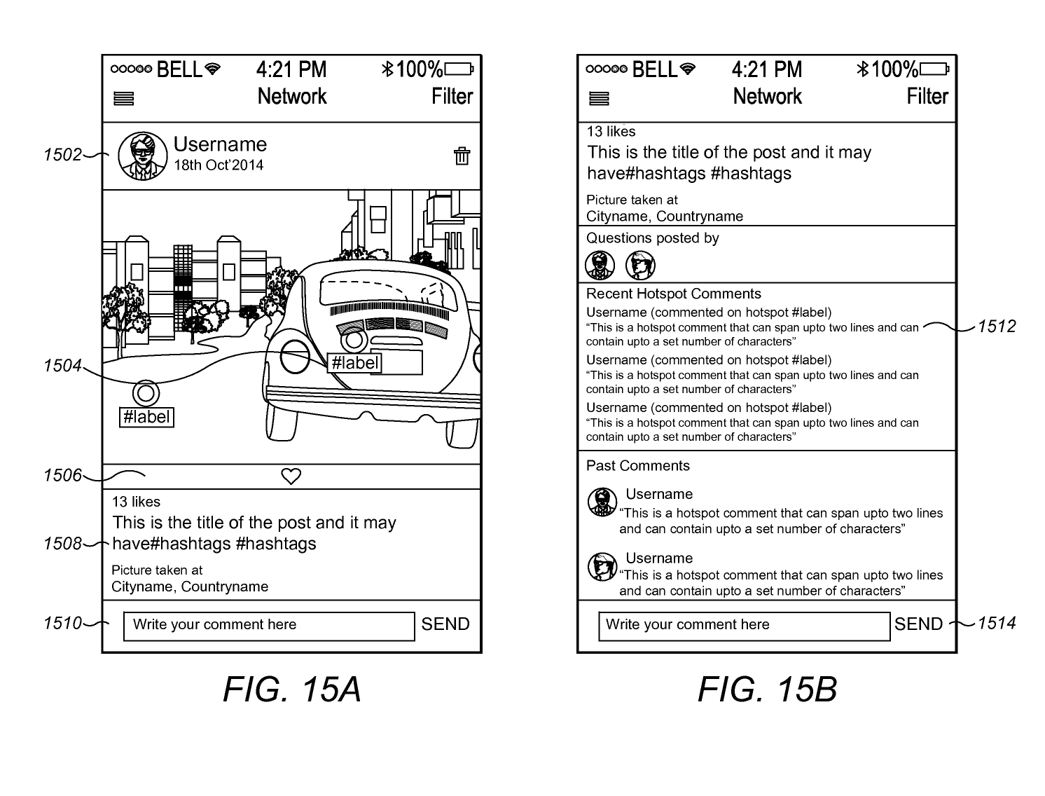

FIG. 8 illustrates the backend intelligence module 208 function that interfaces with publisher intelligence module 202 and the consumer intelligence module 204 through Internet 206. Backend intelligence module 208 comprises of a group of modules that manage the publisher-consumer interactions and the application in totality. The database interface 802 provides the connectivity to the redundant information database 212 where the entire digital objects are handled. The data is kept in redundant database to be fault tolerant. The network interface 804 provides the interface to the Internet 206 and connectivity to the LAN. Alert mechanism 806 raises an alarm when new products, news items, catalogs, promotions and trending items within the subset of the community of interest surfaces. Redundancy management 808 module manages the redundancy of user knowledgebase through fault tolerance techniques enhancing the reliability. The redundancy management module 808 continuously monitors the servers for reliability metrics. Authentication and rules compliance 810 module manages the user details and password functionality. The system intelligence 812 module is the heart of the backend intelligence that handles the server level functionality as a gateway/exchange between the publisher and the consumer. The user management 816 function manages the publisher, consumer and other user level details that have been provided. The privacy of the information is monitored and access control is established as part of this function. The vendor management 818 function manages the vendor information such as product code, inventory available, price, discount, product description, logistics and vendor address. The group management 820 function manages the publisher's contact groups, the dependency and multicast details. The vault management 822 handles the digital object locations in the user devices, dependency and backup. The personal management 824 handles the publisher's information when provided during account set up and the personal information that is provided for verification in case of password loss. The distribution object management 814 works closely with all the modules to give a proper address and location for all queries and inputs. Accounting module 826 provides the accounting feature for all users and keeps track of the funds, credit card details, and other finance related information. Analytics module 828 provides the performance of the system in general and performance per digital object, vendor data and the usage statistics. Analytics module 828 also does multidimensional analysis based on not just the hotspot but with related technology, object, material, location and not just limited to these. For example as shown in FIG. 15A a hotspot 1504 shows a specific location on the image of a car. The producer may desire to know the brand of the paint, the color number or where to get that part such as the bumper fixed. The service provider may subscribe to the hotspot list and may approach the producer with information. Other users may also weigh in to let the producer know about the information. The analytics module may trigger the local service provider to respond based on Geoloc information created by the hotspot attribute on the hotspot. The way finding 830 module provides the information to the consumer to visit the nearest vendor location and the directions. In addition the map function provides embedded information to geographical locations and friend's locations. Advertisement 832 function tracks context sensitive advertisement that is possible for interested advertisers.

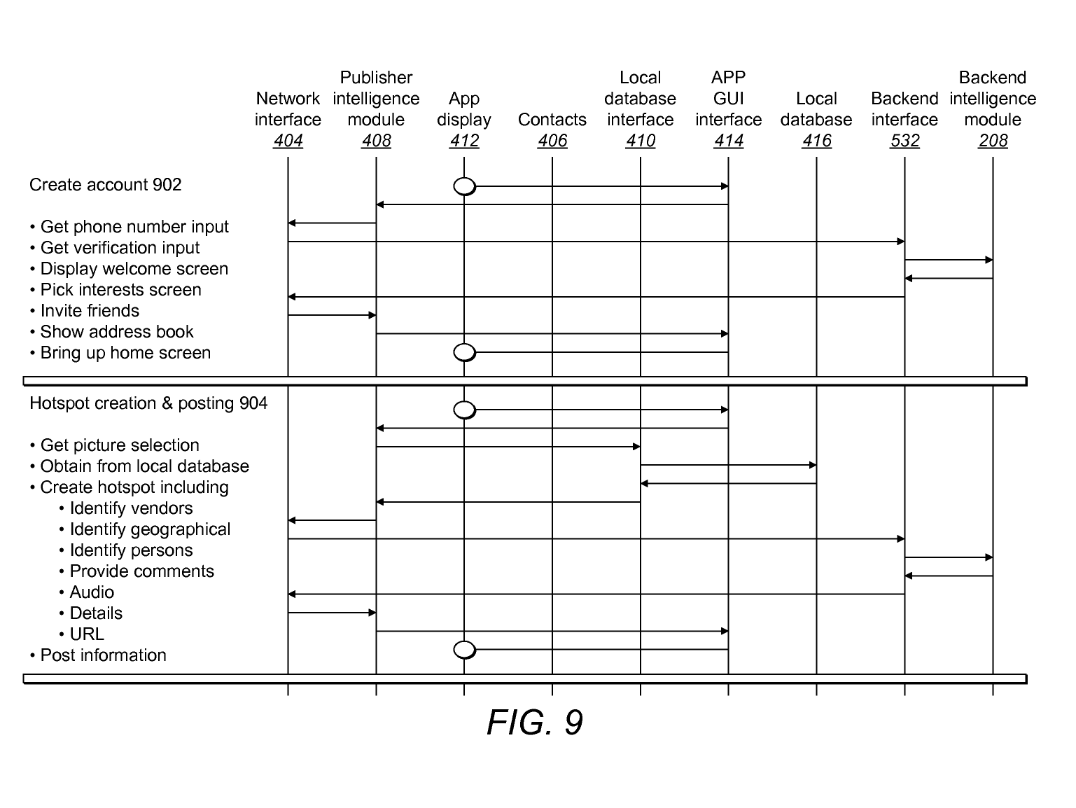

FIG. 9 illustrates two actions performed by the publisher. The first action is to create an account 902. The app display 412 in the device invokes the GUI interface 414 to display the create account screen in the display. The information entered by the user through the interface is transferred to publisher intelligence 408, which communicates the information to backend server intelligence 208 through network interface 404 and backend interface 532. The backend intelligence 208 registers the information such as phone number, verification data and authentication before giving a go ahead to the publisher intelligence 408 via backend interface 532 and network interface 404. The publisher intelligence 408 displays the acceptance in the App display 412 when the publisher intelligence 408 relays the acceptance through app GUI interface 414.

FIG. 9 also illustrates the hotspot create account 902 and hotspot creation and posting 904. The user provides the trigger in the display which is relayed to the publisher intelligence 408 by app display 412 through app GUI interface 414. The picture is selected from the local database 416 through local database interface 410 by the user. The user creates hotspots in the picture, identifies vendors, identifies geographical data, identifies and tags person. The user also provides multi-modal annotations through comments such as audio, text and URL. The transaction is sent to backend intelligence 208 for validity. The user posts the information which is either multicast to the group or broadcast based on user requirements.

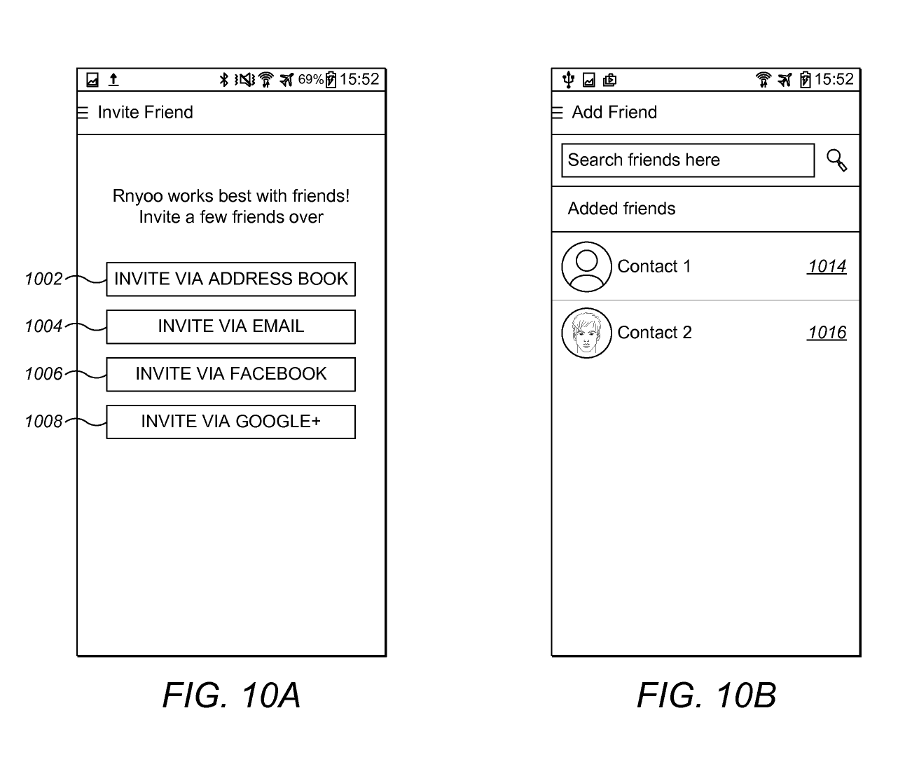

FIG. 10A and 10B shows the software application graphical user interface for the start menu. Multi-modal annotation tool has various features and this feature shows to invite via address book 1002 or invite via email 1004, invite via Facebook 1006 and/or invite via google 1008. The regular features such as adding friends or contact 1014 and 1016 is also enabled. The instant tool enables social media connectivity seamlessly.

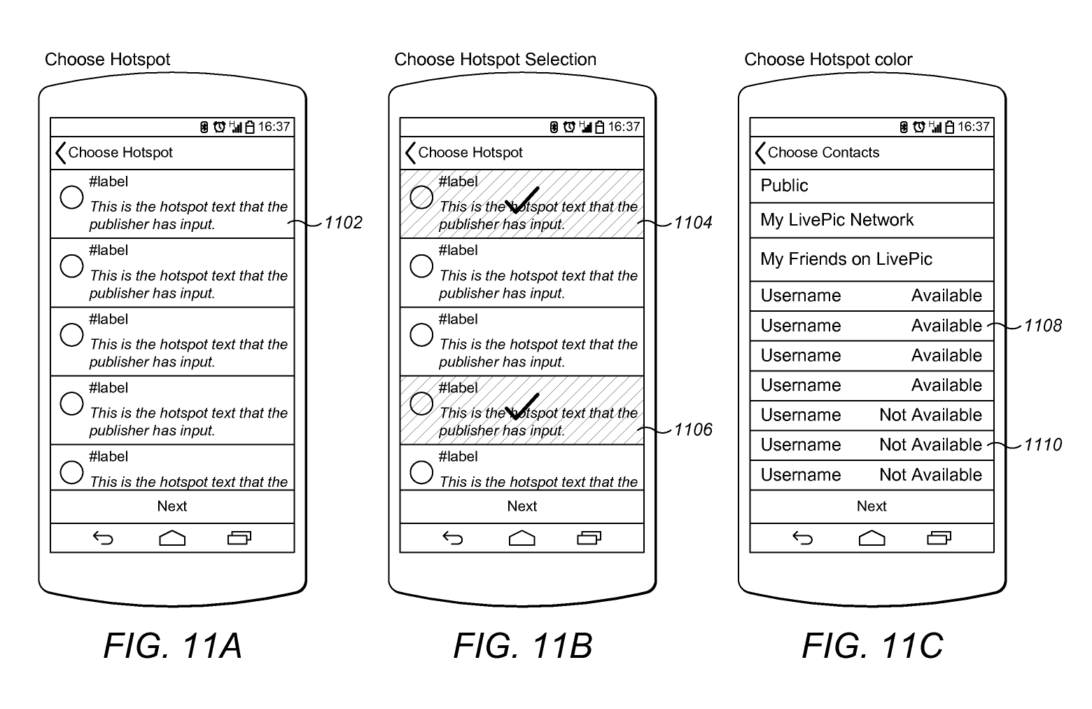

FIG. 11A, 11B and 11C illustrates the work flow of choosing a hotspot 1102 to actually selecting a hotspot 1104 and 1106 to choosing a specific color or a shape for the hotspot attribute addition and then adding the contacts with whom you might want to share the such as 1108 and 1110. Basic building block in the instant system is called “container”. This is also may be described as creating a container. The container comprises of a digital artefact that is sharable to other users and the users and producers in the system using an open standard. The container is composed of a base image, hotspot locations in Cartesian coordinate system along with zoom scale at which those hotspots are created, a machine readable label which unique in the container, description, and optional URL, and comment. A user that creates the container is called publisher. A publisher can add additional media like audio, video, a text/pdf document, as attachments in order to maximize the meaning of the hotspot. Each hotspot contains, (X Y) coordinates in the coordinate space as well as the zoom scale. A hotspot can be created in a normal scale state or a zoomed state. When a container is created, its zoom state, orientation, zoom scale for individual hotspot are retained in order to reproduce the exact scale for visual interpretation on the subscriber's device. Each container content comprises of objects (image, hotspots, and media) are identified uniquely through a unique identifier.

Containers are created on the client's device in both offline and online mode. Before the container can be published all the composite files - image, audio, video and docs have to be uploaded to the server first, in order to obtain the resource identifier. These resource identifiers are then used to build a data format which can be published and shared over the network. The serialization format for transport is JSON.

Containers can act as a template or parent for more than one container, which in turn can act as parent for other container forming a phylogenetic tree of containers, thus enabling the study of how a container evolved over time and shared. Each container can be versioned in time and space, in order to move to a specific version of the container.

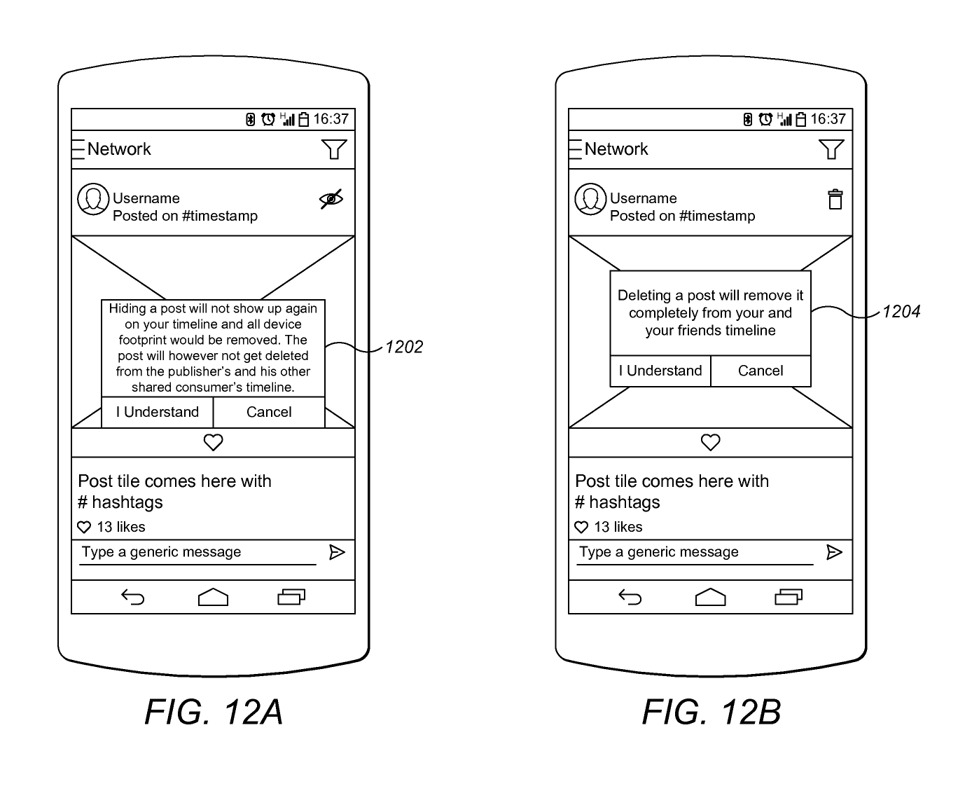

FIG. 12A and 12B shows the unique feature of publisher function. The publisher may elect to choose a specific user to share his multi-modal original annotated file, or elect to hide the posting from the user or allocate a specific time line to post the hotspot from a user as shown in 1202. Publisher also has the option to delete a specific posting in the network 1204. The post would be deleted but the file is stored in the vault and will be owned by the publisher as an original single copy of the multi-modal original annotated file.

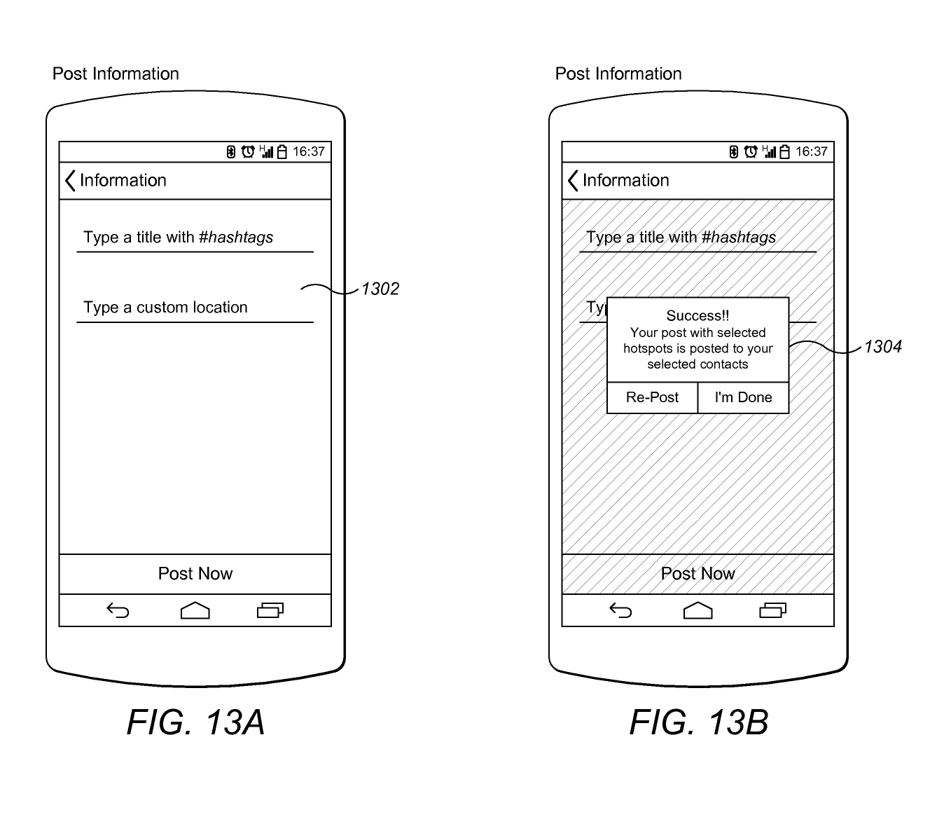

FIG. 13A and 13B shows the process and method of posting using system modules. The posting of the hotspot attribute for a given digital object is done by choosing custom location 1302. Once the post has been done the confirmation is shown as 1304. The post can be reposted if required. The seamless method and process of creating a hotspot attribute to a circle of friends using integrated modules such as publisher intelligence module 408 and backend intelligence module 208 is shown in this invention.

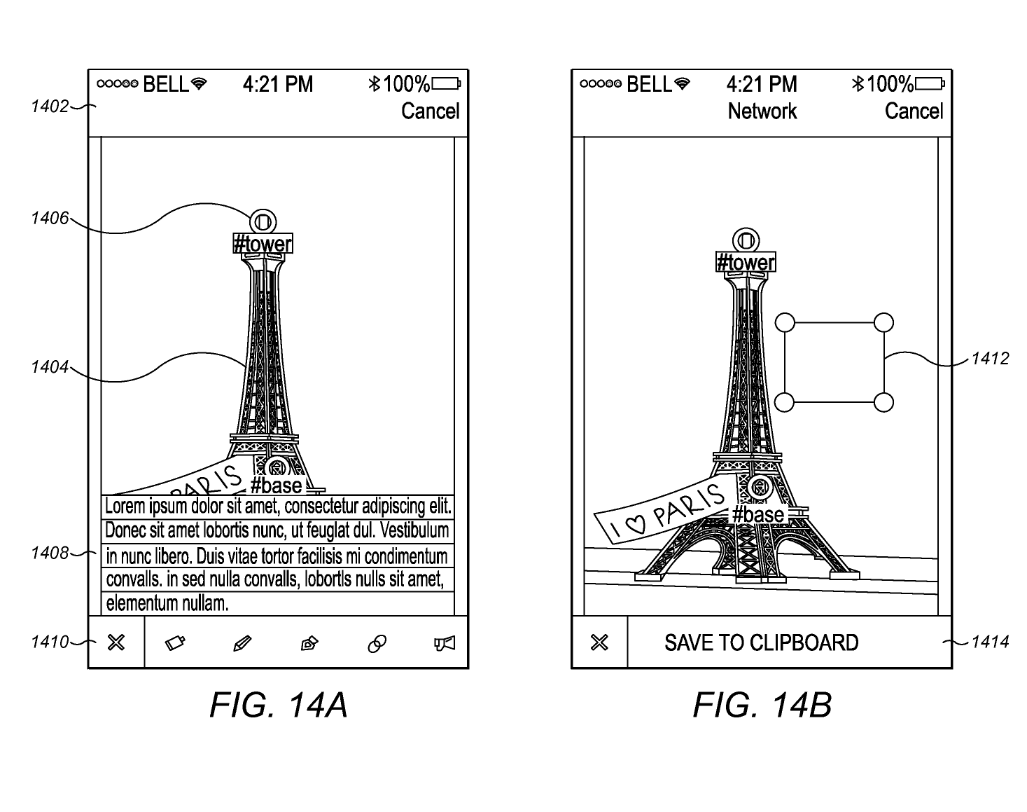

FIG. 14A and 14B shows the interface using a practical example such as a photograph of an Eiffel tower 1404. The photo may have been taken before or at that moment either using the phone camera or a camera. The multi-modal annotation tool is either embedded in the device that is taking the picture or the system level software may be accessed if one signs up to a system or a mobile application is used to retrieve the photograph from the file or storage to annotate. A hotspot type, color, method such as text 1408 or audio, in one embodiment, is selected a hotspot attribute such 1406 is created using the device 1402. Once the hotspot attribute is created the publisher may have very different choices for processing further such as 1410. The user may be able to view the annotated digital image or the digital image by toggling a button on the graphical user interface with or without viewing the hotspot.

In FIG. 14A and 14B a method of creating a digital object by a producer is done using content module 504 of the publisher intelligence module 408. A hotspot module is used to create a hotspot attribute by choosing a specific location of the digital object to create a hotspot attribute. The hotspot module gives you a choice for audio 520, text 522, video 524 and a web connection such as an URL 526. Once annotating the hotspot attribute on the digital object file by the publisher using a multi-modal annotation tool to create a multi-modal original annotated file is done the publisher may choose to share 510 the multi-modal original annotated file with at least one of a single user and multiple users, using the network interface module 404. The publisher may permit the single user or multiple users to comment on the multi-modal annotated file. However, the user may not modify the multi-modal original annotated file. They can only query it. Multi-modal original annotated file is preserved as an only copy to save space and also to manage copyright issues. If the producer likes a certain portion of the digital file they may snip 1412 a portion of the digital object for adding hotspot attribute using multi-modal annotation tool and save it to the clipboard 1414.

The digital image forms a part of the complete display screen, where it shares it with the device information bar 104. The digital image itself, as part of the device screen in one embodiment, shows the Eiffel tower 108. In one embodiment, the digital image, a picture, can be chosen from the gallery. In another embodiment, the digital image can be taken as a picture from the camera. The digital image's multi-modal explanation 108 is provided as part of the screen. In one embodiment, the explanation can be given as a text. In another embodiment, the explanation can be a video clip. In yet another embodiment, the explanation can be provided as an audio clip. Other embodiments are using URL or Geoloc methods as well. Instant methodology handles all the mentioned scenarios. The action screen 110 shows various actions that can be conducted on the digital image. In one embodiment, the digital image shows an embedded hotspot 106 describing the tower. A color to define the hotspot highlighting any section of the digital image by zooming in or out of the picture is possible. The hotspot is categorized based on the objects they define. In one embodiment, the hotspot category could be shopping and other embodiment could be travel. In another embodiment, a portion of the picture can be stored in a clipboard 112 separately and saved 114 for further analysis. In another embodiment, the SNIP and SAVE/SHARE features are available to be used in social media network. In another embodiment, several digital visual images are amalgamated as a collage based on various snips to be defined as a single object.

FIG. 15A and 15B shows another embodiment of annotating hotspot attribute using a specific user name 1502. One may annotate for multiple things such as 1504, model of the car, the color whether one likes it or not 1506. Defining and attaching the hotspot attribute to the digital object seamlessly for ease of portability is technical challenge that has been overcome. The application and/or software are easily portable among the different platforms and operating systems. Comments on the scenery 1508 can be made simultaneously. One may respond with a commentary 1510. Multiple conversations for that particular topic may be discussed in a form 1512. Responses may be sent using 1514 box. The updated multi-modal annotated file when the user or the producer changes the hotspot attribute on the only copy and does not render itself to creating multiple copies.

FIG. 14A and 14B and FIG. 15A and 15B illustrates, in one embodiment, the two important state of the instant user interface that captures both the digital image and the comments from various sources. In another embodiment, the group members can be a broadcast where it is sent without restriction. The conversation in the group is started around the posted visual digital image. The communication between the group members or from anyone to the publisher happens through a comment, question or an answer. The publisher may elect to disseminate the multi-modal annotated file to the user of choice.

In one embodiment, the conversation can be defined as a private one. In another embodiment, the images and hotspots or a portion of it can be defined as public or private. Different elements of the visual image can be shared with different group members.

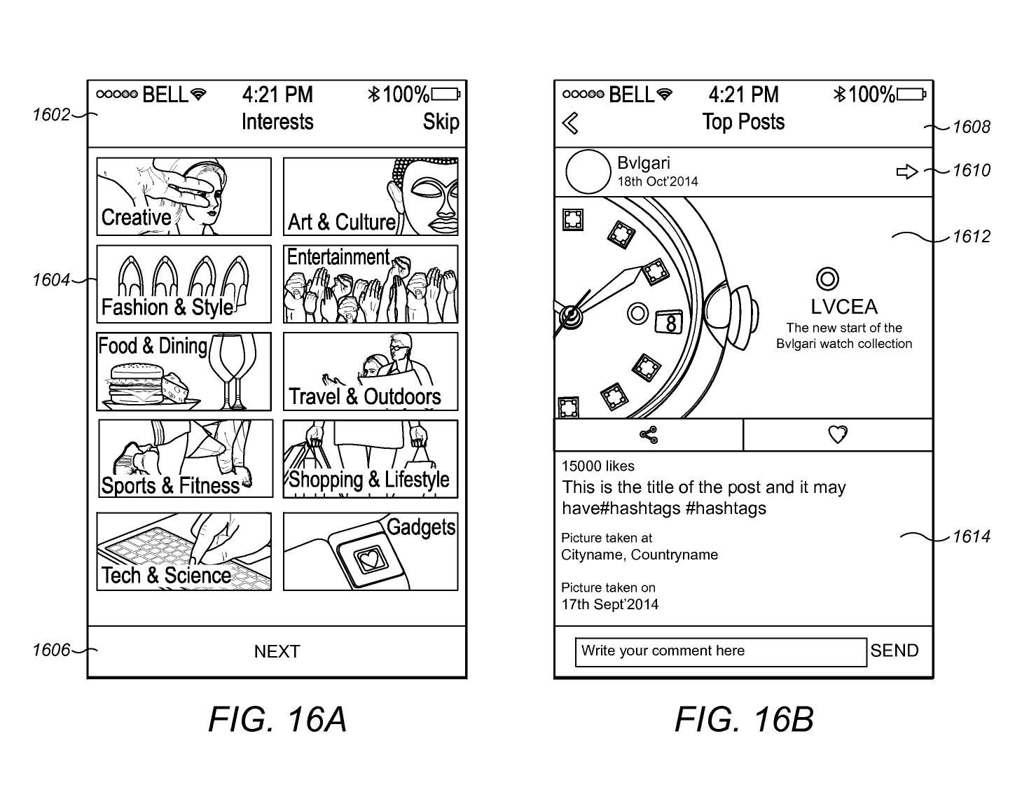

FIG. 16A and 16B illustrates the instant user interface for tracking interests 1602 or community. Areas of interest are chosen 1604 to follow a community of publishers. In one embodiment, specific retailers and their products can be followed. In another embodiment, celebrities can be followed as well. Interests can be chosen from multiple screens 1606 through selection of what is trending within the instant community. Based on the interest, top posts 1608 can be seen on what is trending at any time within the subset of the interest community. A specific item such a trademarked watch 1610 can be chosen and displayed 1612 which may be annotated as a hotspot attributed using multi-modal annotation tool. Comments can be left 1614 based on the posting or the products within the interest group.

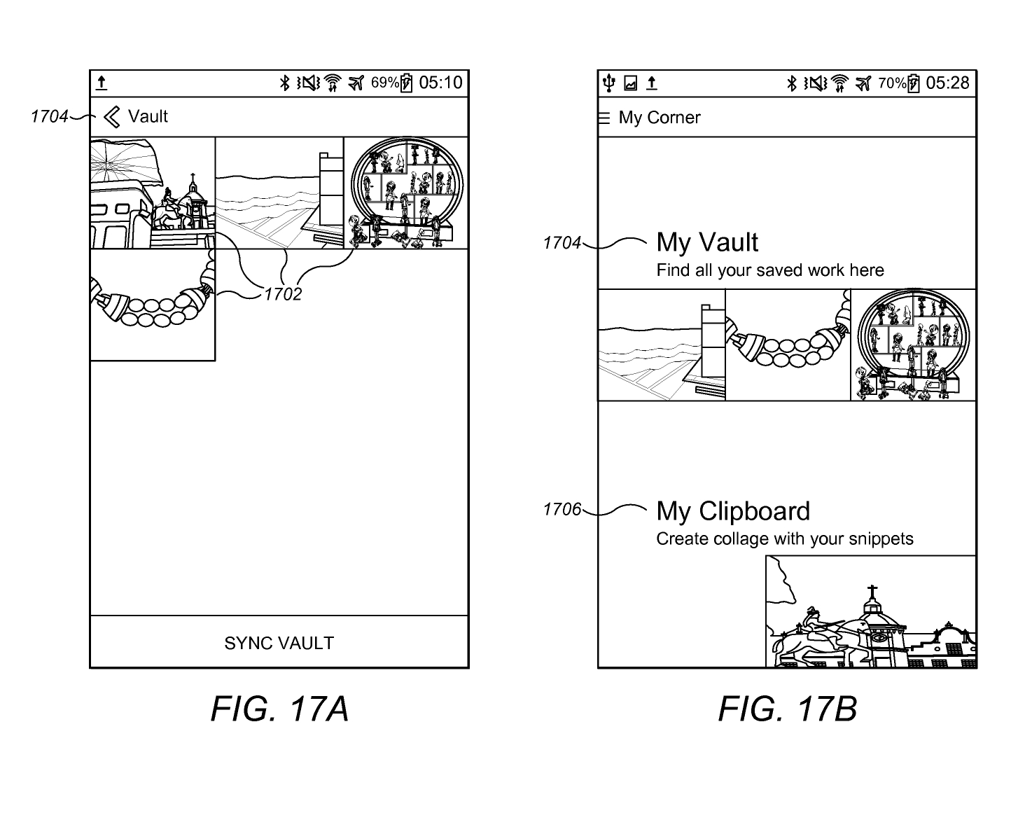

FIG. 17A and 17B shows the function of the vault 1704. The producer may have snipped digital data of various areas that one is interested in and have a repository in the vault that is supported by the backend intelligence module 208 and stored in redundant user database 210 and redundant education knowledge base 212. One may store al their collection of hotspot attributes in the vault 1704. However, they may also add new ones using their clipboard 1706. Categorizing the hotspot attribute maybe done for different reasons and not limited to on what they define as at least one of an object, shopping item and travel tip. Adding to the clipboard and then adding the hotspot attribute to define and attach the hotspot attribute to the digital object seamlessly for ease of portability may be also done before adding to the vault.

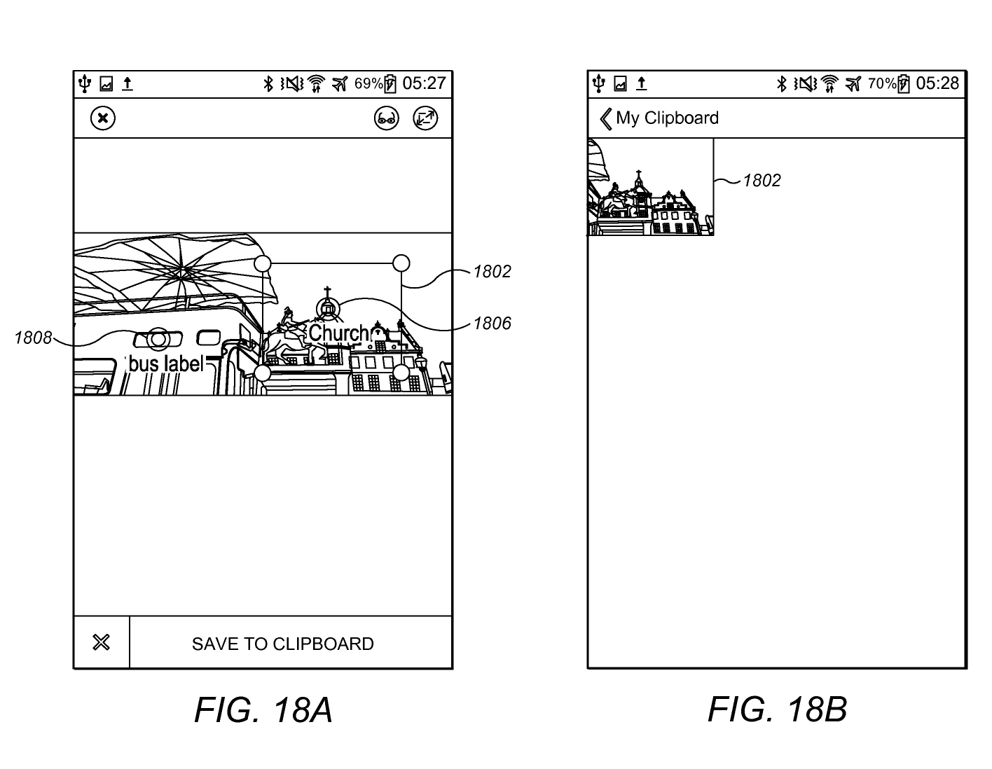

FIG. 18A and 18B shows a digital data being snipped and many pieces of interest being collected by the producer. For example in the scenery a bus label 1808 has been added a hotspot attribute and a snip box 1802 is surrounding the church of interest with a hotspot attribute 1806. The FIG. 18B shows the snipped box is being collected in a clipboard as 1802. The use may later annotate at least one of a digital object and part of an the digital object by at least one of a retrieving from a digital storage and acquiring the digital object by a producer as a hotspot attribute using multi-modal annotation tool and storing an annotated digital object as an original digital object in a vault. The multi-modal annotating tool permits the producer to own the annotated digital object and share the annotated digital object with a user. Limiting the user to at least one of a comment, question and view the annotated digital object and permitting the user to communicate with the producer about the annotated digital object is important to implement strict ownership rules of the digital data. The hotspot attribute annotation on the digital object by the multi-modal annotation tool is done using at least one of a text, audio, video, web address and geological location.

This geographical location annotation is useful in many instances such for travel photography, travel agent or tourism purposes. Even for locating people when they are lost. Better guidance can be set up by law enforcement officials. Even a better mapping of the city and local places can be achieved using this tool. More chatter regarding a particular spot, event or an article will enable the retailers to survey likes and dislikes of people instantly and seamlessly. The digital object is at least one of a photo, video, document and scanned images. The producer is, but not limited to, at least one of an individual, celebrity, retailer, and commercial entity.

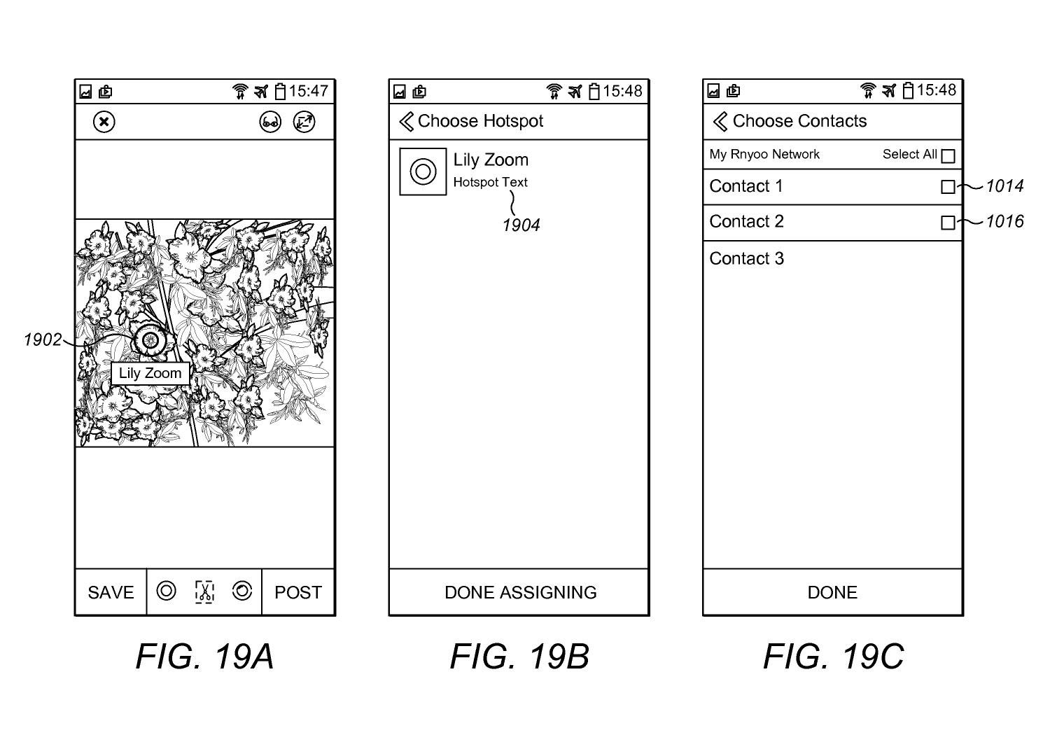

FIG. 19A, 19B and 19C shows and interesting a multipurpose hotspot attribute management. FIG. 19A shows that a producer is using a digital object 1902 which happens to be plant with flowers. A grower may advertise by zooming in on the lily 1904 and post it to his customer list that a particular flower is available for sale. He may choose the contact 1014 and 1016 and send them the hotspot annotated digital object as shown in FIG. 19C. However, if it is a nature enthusiast he may post it as his favorite photo and share it with his contacts. One may also add a video hotspot attribute to it along with a text hotspot attribute and say why this is a rare flower. One may ask a group of friends where to obtain this particular flower. If the nurseries are on the web and have the producer on their contact list they may offer to sell him the particular plant that bears that particular flower. All this may be managed within a close system or only at an application level.

In another example, Digital Imaging and Communications in Medicine (DICOM) is a standard for handling, storing, printing, and transmitting information in medical imaging. Our system will supplement and enhance the images used in the medical field by allowing practitioners to annotate such image (for example x-ray, scans, photograph, etc.,) using hotspots and provide a mechanism for information exchange. Since the annotations can be multi-modal, it will allow practitioners to extend their diagnostics to attach reference information apart from their personal opinions. In the instant application HIPPA compliance may also be incorporated for exchange and transmission of the medical data of a patient.

In another example, due to complying with DICOM and HIPPA it could be an excellent educational tool for telemedicine and also training purposes. The hotspot annotation also will help supplement regular teaching methods and allow teachers to use additional pictorial methods to reach different student populations.

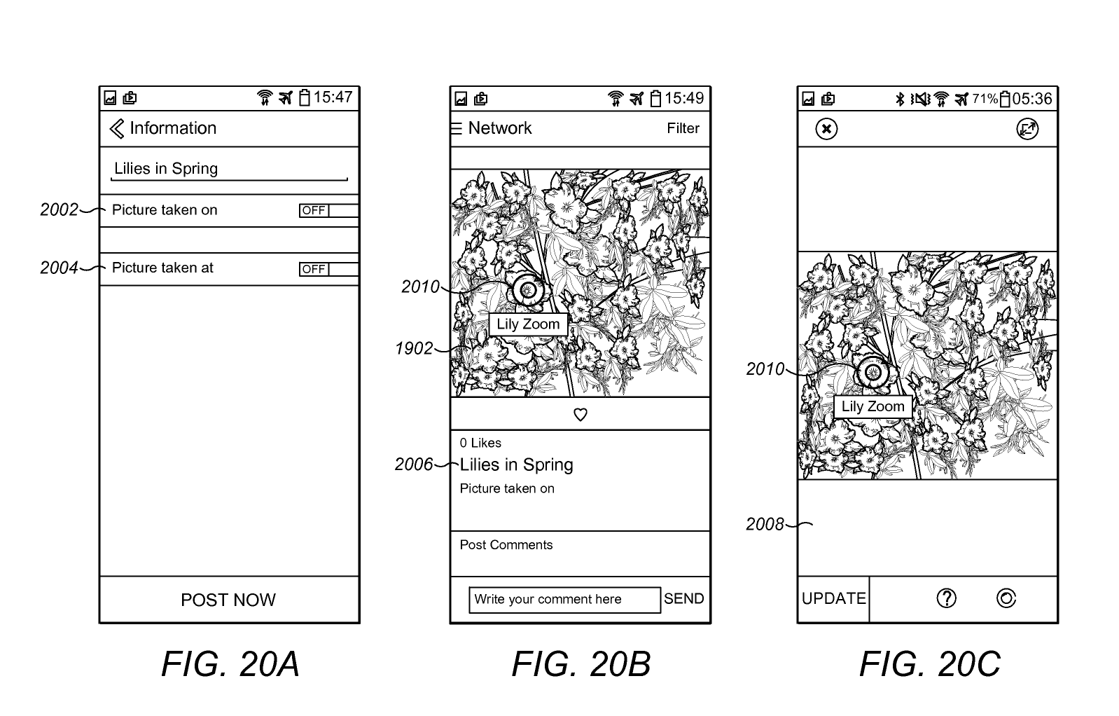

FIG. 20A, 20B and 20C shows more controls that a producer may have. For example when was the picture taken 2002 and where was it taken 2004. The producer may comment on the whole digital data 2010 in text while posting 2006. However, the user may see the whole digital data 2010 with the hotspot attribute and be allowed to comment 2008.

In addition, it will be appreciated that the various systems, methods and processes disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

### INDUSTRIAL APPLICABILITY

The multi-modal annotation tool overcomes a lot of technical difficulties and gaps that is present in providing seamless annotation of digital objects. The superior technology of creating a container with hotspot attributes that seamlessly transports even after the digital object has been cut and/or pasted by the producer and also remains as the only digital object copy that is owned by the producer is novel. Sharing the hotspot attribute annotated digital object for user to see, sort according to relevance and managing redundancy for storage is an advantage over existing technology. This technology is easy to use, share and saves space. The enormous digital objects being created and correctly annotated by the producer before distribution adds value for the product and makes communication between people more relevant.

What is claimed is:

1. A computer system, comprising:
a computer processor and a memory, wherein the processor executes instructions stored in the memory to perform the following:
annotating a hotspot attribute on a digital object using a multi-modal annotation tool, the annotation being performed by a publisher of the digital object, wherein the digital object is owned by the publisher and only a single version of the digital object is stored in a database, wherein the hotspot attribute are relatively positioned to the digital object and move relative to the orientation of the digital object;
zooming the digital object to annotate a hotspot accurately and sharing only certain hotspots with certain user and making the hotspot; wherein the associated annotations visible in the same zoom level set by the publisher only to an intended user and not all users;
managing an access of a part of the digital object, wherein the managing comprising selecting, updating, deleting and sending a part of the digital object to a user, wherein the user cannot modify the hotspot but can comment and/or ask a question related to the hotspot;
creating a single file with the hotspot attribute on the digital object and electing to send either the hotspot attribute part of the digital object to the user or part of the digital object to the user;
specifically assigning certain hotspot to a certain user and only that user receives the digital object from the publisher; and
a network interface component to communicate between the publisher and the user to maintain contextual communication with regard to the annotation.

2. The system of claim 1, further comprising:
storing the annotated hotspot attribute using a vault management for the publisher's content.

3. The system of claim 1, wherein the hotspot attribute is at least one of a text, audio, video, web address and geological location.

4. The system of claim 2, further comprising:
categorizing the annotated hotspot for a given collection in a vault of the publisher and the user.

5. The system of claim 1, wherein the digital object is at least one of a photo, video, document and scanned images.

6. The system of claim 1, wherein the computer system is at least one of an application, enterprise software and embedded software.

7. A method, comprising:
creating a digital object by a producer;
choosing a specific location of the digital object to create a hotspot attribute;
annotating the hotspot attribute on the digital object by the publisher using a multi-modal annotation tool to create a multi-modal original annotated file;
zooming into the digital object and set the annotation of the hotspot and save the zoomed state for the user to view in the set context;
selectively sharing the multi-modal original annotated file with at least one of a single user and multiple users;
permitting the single user or the multiple users to comment on the multi-modal annotated file and not allowing for the user to save a copy;
preserving the multi-modal annotated file as an only copy;
updating the multi-modal annotated file the producer changes the hotspot attribute on the only copy; and
electing to disseminate the multi-modal annotated file selectively to the single user or the multiple users.

8. The method of claim 7, further comprising:
categorizing the hotspot attribute based on what they define as at least one of an object, shopping item and travel tip.

9. The method of claim 7, further comprising:
snipping a portion of the digital object for adding hotspot attribute using multi-modal annotation tool.

10. The method of claim 9, further comprising:
defining and attaching the hotspot attribute to the digital object seamlessly for ease of portability.

11. The method of claim 7, further comprising:
selectively sharing the multi-modal annotated file with a specific individual annotation on a hotspot with different users to maintain different private conversations around the same digital object.

12. A method, comprising:
annotating at least one of a digital object and part of an the digital object by at least one of a retrieving from a digital storage and acquiring the digital object by a publisher after zooming the digital object to select to attach a hotspot at a particular spot, as a hotspot attribute using multi-modal annotation tool;
storing an annotated digital object as an original digital object in a vault; and
permitting the publisher to own the annotated digital object and share the annotated digital object with an user.

13. The method of claim 12, further comprising:
limiting the user to at least one of a comment, question and view the annotated digital object; and
permitting the user to communicate with the publisher about the annotated digital object.

14. The method of claim 13, wherein the hotspot attribute annotation on the digital object by the multi-modal annotation tool is done using at least one of a text, audio, video, web address and geological location.

15. The method of claim 12, further comprising:
managing redundancy by storing only the original digital object used by the publisher in the vault.

16. The method of claim 12, wherein the digital object is at least one of a photo, video, document and scanned images.

17. The method of claim 12, wherein the publisher is at least one of an individual, celebrity, retailer, and commercial entity.
